(19) United States
(12) Patent Application Publication
(10) Pub. No.: US 2025/0353742 A1
(43) Pub. Date: Nov. 20, 2025

(54) HYDROGEN PRODUCTION VIA STEAM REFORMING OVER RED-MUD SUPPORTED NICKEL CATALYST AND METHODS OF PREPARATION THEREOF

(71) Applicant: KING FAHD UNIVERSITY OF PETROLEUM AND MINERALS, Dhahran (SA)

(72) Inventors: Galal Atef Ahmed NASSER, Dhahran (SA); Akolade Idris BAKARE, Dhahran (SA); Mohammed Ahmed SANHOOB, Dhahran (SA); Mohammad M. HOSSAIN, Dhahran (SA); Zuhair Omar MALAIBARI, Dhahran (SA); Ali Abdullah AL QADRI, Dhahran (SA)

(73) Assignee: KING FAHD UNIVERSITY OF PETROLEUM AND MINERALS, Dhahran (SA)

(21) Appl. No.: 18/679,618

(22) Filed: May 31, 2024

(30) Foreign Application Priority Data
May 15, 2024 (SA) 1020242617

(51) Int. Cl. C01B 3/40; B01J 8/02; B01J 21/16; B01J 23/755; B01J 37/03; B01J 37/04; B01J 37/08; B01J 37/18; C01B 3/50

(52) U.S. Cl. CPC C01B 3/40; B01J 8/0278; B01J 21/16; B01J 23/755; B01J 37/035; B01J 37/04; B01J 37/088; B01J 37/18; C01B 3/50; C01B 2203/0233; C01B 2203/0805; C01B 2203/1058; C01B 2203/1082; C01B 2203/1247

(57) ABSTRACT

A method for producing hydrogen (H₂) from a hydrocarbon-containing fluid uses a red mud-supported nickel (Ni-SRM) catalyst, where the Ni is present at a concentration of 0.01 to 30 wt. % based on the total weight of the Ni-SRM catalyst to convert hydrocarbons in the hydrocarbon-containing fluid to H₂. The method has a hydrocarbon conversion of at least 85% based on the initial weight of the hydrocarbon present in the hydrocarbon-containing fluid. The H₂ yield using the Ni-SRM catalyst is about 50 to 80% based on the hydrocarbon conversion.

### CROSS REFERENCE TO RELATED APPLICATIONS

The present disclosure claims the benefit of Saudi Patent Application No. 1020242617 filed on May 15, 2024, with the Saudi Authority for Intellectual Property Office, which is incorporated herein by reference in its entirety. Patent application titled “Hydrogen Production by Steam Reforming of Dodecane Using Nickel-Red Mud Catalyst” (attorney docket 552069US) is incorporated herein by reference.

### BACKGROUND

### Technical Field

The present disclosure is directed toward a method for hydrogen (H₂) production, more particularly, to red mud-supported nickel-based catalysts (Ni-SRM) for H₂ production.

### Description of Related Art

The “background” description provided herein is to present the context of the disclosure generally. Work of the presently named inventors, to the extent it is described in this background section, as well as aspects of the description that may not otherwise qualify as prior art at the time of filing, are neither expressly nor impliedly admitted as prior art against the present invention.

With a continuous rise in global production, cleaner, and greener fuels are in great demand. These fuels are required to be environmentally friendly to improve their sustainability. Presently, hydrogen is considered to be one such green fuel. Hydrogen is a clean fuel with a high heating value of about 120-140 megajoules per kilogram (MJ/kg), which in turn is relatively higher than the heating value of natural gas of about 47-55 MJ/kg. Hydrogen is not readily available in nature, but hydrogen may be produced from a plurality of resources such as coal, fossil fuel, water, biomass, and wastes through different processes such as gasification in the presence of steam, electrolysis, and thermochemical processes. Hydrogen produced from the splitting of water is of high purity, and the power used in this process may be from renewable resources. However, the hydrogen produced through this process is expensive and has a scaling-up limitation. While coal gasification and steam reforming of natural gas are mature processes, the hydrogen produced from these technologies is suitable for Fisher-Tropsch synthesis (FTS) and ammonia synthesis. Transportation fuel, such as diesel and gasoline, possesses higher content of hydrogen to carbon ratio and high energy efficiency (See: Dincer I, Acar C. Review and evaluation of hydrogen production methods for better sustainability and Shekhawat D, Spivey J J, Berry D A. Introduction to fuel processing. fuel cells technol fuel process). Therefore, fuel reforming with CO₂ capture is a promising method for blue H₂ production.

There are various methods for liquid fuel reforming, such as, but not limited to, autothermal reforming (ATR), partial oxidation (PO), plasma reforming, microwave reforming, and steam reforming (SR). Further, diesel steam reforming (DSR) and gasoline steam reforming may be employed for hydrogen/syngas production. The advantage of utilizing liquid fuel is that the infrastructure is well established, and thus, fuel may be transported easily to a site and reformed. Further, significant problems associated with fuel are the complexity of different kinds of compounds and catalyst deactivation because of coke formation, sintering, and poisoning due to sulfur content in the diesel. Therefore, robust catalysts that reduce coke formation, suppress sintering and possess a high tolerance for sulfur are highly required. Presently, catalysts based on noble metals such as rhodium (Rh), ruthenium (Ru), palladium (Pd), and platinum (Pt) have been shown to have superior activity in reforming with good resistance to coke formation and sintering. However, these metals are expensive, and alternatively cheaper, competitive metals such as nickel (Ni), cobalt (Co), and copper (Cu) are currently being studied for the development of efficient and economical steam reforming catalysts for hydrogen and syngas production. Fabricating a catalyst with a strong interaction between metal and support may mitigate the coke formation and metal sintering. Sulfur poisoning may be mitigated by introducing other metals, such as alkaline earth metals, or by incorporating base metals that may oxidize or store the sulfur (See: Ashok J, Das S, Dewangan N, Kawi S. Steam reforming of surrogate diesel model over hydrotalcite-derived MO—CaO—Al₂O₃ (M=Ni & Co) catalysts for SOFC applications).

Furthermore, efficient catalysts or catalyst carriers, such as red mud, are explored. Red mud is an industrial waste material produced by the Bayer process for making aluminum oxide. Due to the large amounts produced, they are difficult to dispose of. This is characterized as a global problem that requires an immediate solution involving recycling or reuse rather than landfilling (See: Power G, Gräfe M, Klauber C. Bauxite residue issues: I. Current management, disposal, and storage practices). Several transition metals and other metals are found in red mud, which are of interest and may be used in various commercial catalytic processes. Metals like iron and aluminum are typically present at considerable concentrations in red mud, along with other metals in lesser amounts. Therefore, a need arises for an efficient and economical process that may address the problems of green production of hydrogen as well as red mud waste disposal.

Although several red mud-based catalysts were used in the past for hydrogen production, each suffered from drawbacks hindering their adoption. Accordingly, an object of the present disclosure is to prepare a catalyst that overcomes the limitations of the art.

### SUMMARY

In an exemplary embodiment, a method for producing hydrogen (H₂) is described. The method includes introducing a H₂-containing feed gas stream into a reactor containing a red mud supported nickel (Ni-SRM) catalyst including Ni-SRM catalyst particles. The Ni is present in the Ni-SRM catalyst at a concentration of 0.01 weight percentage (wt. %) to 30 wt. % based on a total weight of the Ni-SRM catalyst. The method further includes passing the H₂-containing feed gas stream through the reactor to contact the H₂-containing feed gas stream with the Ni-SRM catalyst particles at a temperature of from 600° C. to 800° C. to form an activated Ni-SRM catalyst. Afterwards, the method includes terminating the introducing the H₂-containing feed gas stream, and simultaneously introducing and passing a hydrocarbon-containing fluid and a water vapor stream through the reactor to contact the hydrocarbon-containing fluid, and the water vapor stream with the activated Ni-SRM catalyst at a temperature of from 600° C. to 800° C. thereby converting at least a portion of the hydrocarbon to H₂, and producing a residue gas stream leaving the reactor. The method further includes separating the H₂ from the residue gas stream to generate a H₂-containing product gas stream.

In some embodiments, the reactor is at least one selected from a group consisting of a fixed-bed reactor, a trickle-bed reactor, a moving bed reactor, a rotating bed reactor, a fluidized bed reactor, and a slurry reactor.

In some embodiments, the reactor is a fixed-bed reactor in the form of a cylindrical reactor including a top portion, a cylindrical body portion, a bottom portion, a housing having an open top and open bottom supportably maintained with the cylindrical body portion. The Ni-SRM catalyst is supportably retained within the housing, permitting fluid flow therethrough. At least one propeller agitator is disposed in the bottom portion of the reactor; the bottom portion is cone-shaped or pyramidal, and a plurality of recirculation tubes fluidly connects the bottom portion of the cylindrical reactor with the cylindrical body portion of the cylindrical reactor.

In some embodiments, the H₂ is present in the H₂-containing feed gas stream at a concentration of 90 volume percentage (vol. %) to 99.99 vol. % based on a total volume of the H₂-containing feed gas stream.

In some embodiments, the hydrocarbon is present in the hydrocarbon-containing fluid at a concentration of 50 to 95 vol. % based on a total volume of the hydrocarbon-containing fluid.

In some embodiments, the hydrocarbon-containing fluid further includes an inert gas selected from the group consisting of nitrogen, argon, and helium.

In some embodiments, a flow rate of the hydrocarbon-containing fluid to the water vapor stream introduced into the reactor is about 5:1 to 1:5.

In some embodiments, the method includes introducing and passing the hydrocarbon-containing fluid, and the water vapor stream through the reactor is performed at a weight hourly space velocity (WHSV) of about 4.5 h⁻¹ at a temperature of about 700° C.

In some embodiments, the hydrocarbon-containing fluid is a diesel oil, including one or more C8 to C25 aliphatic hydrocarbons.

In some embodiments, the hydrocarbon-containing fluid includes dodecane.

In some embodiments, the hydrocarbon-containing fluid is dodecane, and the residue gas stream includes H₂, BTX, C5-C6 hydrocarbon, a C4 olefin, propylene, ethylene, ethane, methane, CO, CO₂, or mixtures thereof.

In some embodiments, the BTX includes benzene, toluene, ethylbenzene, p-xylene, m-xylene, o-xylene, or mixtures thereof.

In some embodiments, the C5-C6 hydrocarbon includes pentane, pentene, pentyne, hexane, hexene, hexyne, cyclohexane, cyclohexene, or mixtures thereof.

In some embodiments, the method has a hydrocarbon conversion of at least to 85% based on an initial weight of the hydrocarbon present in the hydrocarbon-containing fluid.

In some embodiments, the method has a H₂ yield of 50 to 80% based on the hydrocarbon conversion.

In another exemplary embodiment, a method of preparing the red mud-supported nickel-based catalyst (Ni-SRM) is described. The method includes calcining a red mud material at a temperature of about 600 to 900° C. to form a calcined red mud material, mixing a nickel salt and a first solvent to form a first mixture, adjusting a pH of the first mixture to about 9, and mixing with the calcined red mud material to form a reaction mixture. The method further includes heating the reaction mixture to form a catalyst precursor in the reaction mixture and precipitating the catalyst precursor from the reaction mixture by cooling and calcining at a temperature of about 550° C. to form the Ni-SRM catalyst. The Ni is present in the Ni-SRM catalyst at a concentration of 10 to 20 wt. % based on a total weight of the Ni-SRM catalyst.

In some embodiments, the red mud material has an average particle size of about 80 micrometers (μm) to 150 μm.

In some embodiments, the method includes calcining the red mud material at a temperature of about 750° C.

In some embodiments, the nickel salt includes nickel sulfate, nickel acetate, nickel citrate, nickel iodide, nickel chloride, nickel perchlorate, nickel nitrate, nickel phosphate, nickel triflate, nickel bis(trifluoromethanesulfonyl)imide, nickel tetrafluoroborate, nickel bromide, and/or its hydrate.

In some embodiments, the adjusting of the pH is performed by adding an alkali solution into the first mixture, and the alkali solution includes at least one alkali salt selected from the group consisting of potassium hydroxide (KOH), sodium hydroxide (NaOH), calcium hydroxide (Ca(OH)₂), potassium carbonate (K₂CO₃), sodium carbonate (Na₂CO₃), calcium carbonate (Ca₂CO₃), or mixtures thereof.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a flowchart illustrating a method for producing hydrogen (H₂), according to certain embodiments.

FIG. 1B is a flowchart illustrating a method for preparing a red mud-supported nickel-based catalyst (Ni-SRM), according to certain embodiments.

FIG. 2 is a graph showing X-ray diffraction (XRD) spectra of red mud before and after modifications, according to certain embodiments.

FIG. 3 shows hydrogen-temperature programmed reduction (H₂-TPR) profile of the Ni-SRM catalyst, according to certain embodiments.

FIG. 4 shows product distribution of thermal steam reforming of n-dodecane, according to certain embodiments.

FIG. 5 shows product distribution of n-dodecane over unmodified red mud, according to certain embodiments.

FIG. 6 shows product distribution of steam reforming of n-dodecane over modified red mud with 10 weight percentage (wt. %) of Ni, according to certain embodiments.

FIG. 7 shows product distribution of steam reforming of n-dodecane over modified red mud with 20 wt. % of Ni, according to certain embodiments.

### DETAILED DESCRIPTION

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all embodiments of the disclosure are shown.

In the drawings, reference numerals designate identical or corresponding parts throughout the several views. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

As used herein, the terms “particle size” and “pore size” may be thought of as the lengths or longest dimensions of a particle and of a pore opening, respectively.

As used herein, the term “ultrasonication” or “sonication” refers to the process in which sound waves are used to agitate particles in a solution.

As used herein the term “deionized water” refers to the water that has (most of) the ions removed.

As used herein, the term “calcination” refers to heating a compound to a high temperature, under a restricted supply of ambient oxygen. This is performed to remove impurities or volatile substances and to incur thermal decomposition.

As used herein, the term “thermal decomposition (or thermolysis)” refers to a chemical decomposition initiated by heat. The decomposition temperature is the temperature at which a substance undergoes chemical decomposition.

As used herein, the term ‘temperature-programmed reduction (TPR)’ refers to a technique for characterizing solid materials. It is often used in heterogeneous catalysis to find the optimal reduction conditions.

As used herein, the term “aspect ratio” refers to the ratio of length to width of cylinder.

As used herein, the term “weight hourly space velocity (WHSV)” refers to the weight of feed flowing per unit weight of the catalyst per hour.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

Catalyst selectivity is the amount of the target compound or element formed from an amount of feedstock, e.g., selectivity (%)=(mol desired product (e.g., H₂))/(mol starting compound-mol starting compound (e.g., dodecane) left after reaction)*100.

$$Product selectivity ( \% ) = \frac{Moles of desired product \times 100}{Moles of total products}$$

The present disclosure is intended to include all hydration states of a given compound or formula, unless otherwise noted or when heating a material.

The present disclosure is intended to include all isotopes of a given compound or formula, unless otherwise noted. In addition, the present disclosure is intended to include all isotopes of atoms occurring in the present compounds and complexes. Isotopes include those atoms having the same atomic number but different mass numbers. By way of general example, and without limitation, isotopes of hydrogen include deuterium and tritium. Isotopes of naturally occurring nickel ²⁸Ni include ⁵⁸Ni, ⁶⁰Ni, ⁶¹Ni, ⁶²Ni, and ⁶⁴Ni. Isotopes of iron include ⁵⁴Fe, ⁵⁶Fe, ⁵⁷Fe, and ⁵⁸Fe and isotopes of oxygen include ¹⁶O, ¹⁷O, and ¹⁸O. Isotopically-labeled compounds of the disclosure may generally be prepared by conventional techniques known to those skilled in the art or by processes analogous to those described herein, using an appropriate isotopically-labeled reagent in place of the non-labeled reagent otherwise employed.

Aspects of the present disclosure are directed towards hydrogen production via steam reforming of heavier hydrocarbon compositions such as diesel and surrogate diesel. The use of modified red mud waste material as a catalyst support, particularly Saudi Red Mud (SRM), is a cost-effective and efficient solution to meet the rising demand for clean and sustainable energy sources. This method of the present disclosure provides a sustainable way to produce hydrogen with enhanced efficiency and selectivity.

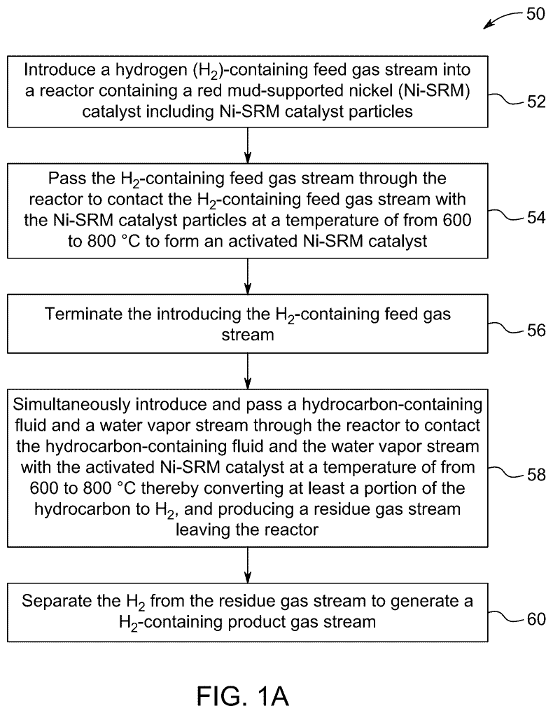

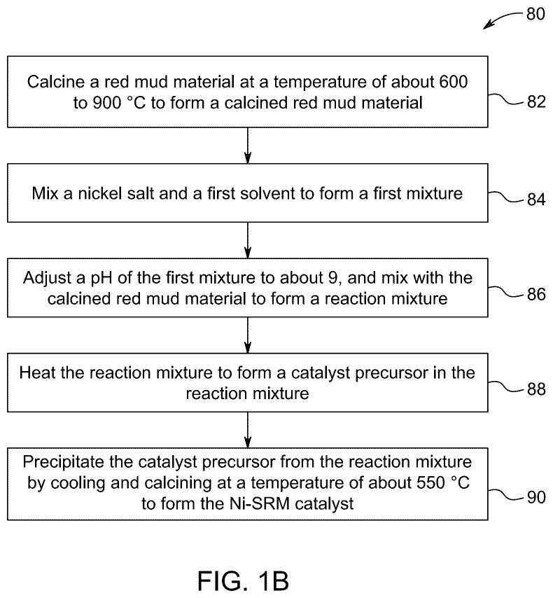

FIG. 1A illustrates a flow chart of a method 50 for producing hydrogen (H₂). The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes introducing a H₂-containing feed gas stream into a reactor containing a red mud supported nickel (Ni-SRM) catalyst including Ni-SRM catalyst particles. In some embodiments, the H₂ is present in the H₂-containing feed gas stream at a concentration of 90-99.99 vol. %, preferably 90.5-99.5 vol. %, preferably 91-99 vol. %, preferably 91.5-98.5 vol. %, preferably 92-98 vol. %, preferably 92.5-97.5 vol. %, preferably 93-97 vol. %, preferably 93.5-96.5 vol. %, preferably 94-96 vol. %, preferably 94.5-95.5 vol. %, based on the total volume of the H₂-containing feed gas stream.

In some embodiments, the reactor is at least one selected from the group consisting of a fixed-bed reactor, a trickle-bed reactor, a moving bed reactor, a rotating bed reactor, a fluidized bed reactor, and a slurry reactor. In a preferred embodiment, the reactor is a fixed-bed reactor. In an embodiment, the reactor is the fixed-bed reactor in the form of a cylindrical reactor including a top portion, a cylindrical body portion, a bottom portion, and a housing having an open top and open bottom supportably maintained with the cylindrical body portion. In some embodiments, the Ni-SRM is supportably retained within the housing permitting fluid flow therethrough. In some embodiments, the bottom portion is cone-shaped or pyramidal. In some embodiments, at least one propeller agitator is disposed of in the bottom portion of the reactor. In some embodiments, a plurality of recirculation tubes fluidly connects the bottom portion of the cylindrical reactor with the cylindrical body portion of the cylindrical reactor. In some embodiments, at least one propeller agitator disposed in the bottom portion of the reactor.

At step 54, the method 50 includes passing the H₂-containing feed gas stream through the reactor to contact the H₂-containing feed gas stream with the Ni-SRM catalyst particles at a temperature of 600-800 degrees Celsius (° C.), preferably 610-790° C., preferably 620-780° C., preferably 630-770° C., preferably 640-760° C., and preferably 650-750° C., to form an activated Ni-SRM catalyst. In a preferred embodiment, the H₂-containing feed gas stream is passed through the reactor to contact the H₂-containing feed gas stream with particles of the catalyst at a temperature of 700° C. to form a reduced catalyst.

At step 56, the method 50 includes terminating the introducing the H₂-containing feed gas stream. Subsequently, the reactor temperature is set to the targeted reaction condition under a continuous flow of an inert gas, preferably nitrogen, preferably argon, and more preferably helium.

At step 58, the method 50 includes simultaneously introducing and passing a hydrocarbon-containing fluid, e.g., in liquid, supercritical or gaseous form, and a water vapor stream through the reactor to contact the hydrocarbon-containing fluid and the water vapor stream with the activated Ni-SRM catalyst at a temperature of from 600-800° C., preferably 610-790° C., preferably 620-780° C., preferably 630-770° C., preferably 640-760° C., and preferably 650-750° C., thereby converting at least a portion of the hydrocarbon to H₂, and producing a residue gas stream leaving the reactor.

In some embodiments, the steps of introducing and passing the hydrocarbon-containing fluid and the water vapor stream through the reactor are performed at a weight hourly space velocity (WHSV) of about 4-5 h⁻¹, preferably 4.1-4.9 h⁻¹, preferably 4.2-4.8 h⁻¹, preferably 4.3-4.7 h⁻¹, preferably 4.4-4.6 h⁻¹, at a temperature of from 600-800° C., preferably 610-790° C., preferably 620-780° C., preferably 630-770° C., preferably 640-760° C., and preferably 650-750° C. In a preferred embodiment, the introduction and passage of the hydrocarbon-containing fluid and the water vapor stream through the reactor is performed at a WHSV of about 4.5 h⁻¹ at a temperature of about 700° C.

In some embodiments, hydrocarbon is present in the hydrocarbon-containing fluid at a concentration of 50-95 vol. %, preferably 55-90 vol. %, preferably 60-85 vol. %, preferably 65-80 vol. %, and preferably 70-75 vol. %, based on a total volume of the hydrocarbon-containing fluid. In some embodiments, the hydrocarbon-containing fluid further includes an inert gas selected from the group consisting of nitrogen, argon, and helium. In a preferred embodiment, the hydrocarbon-containing fluid further includes nitrogen gas as the inert gas. In some embodiments, a flow rate of the hydrocarbon-containing fluid to the water vapor stream introduced into the reactor is about 5:1 to 1:5, preferably 4:1 to 1:4, preferably 3:1 to 1:3, preferably 2:1 to 1:2, and more preferably 1:1.

The hydrocarbon-containing fluid is a diesel oil including one or more C₈ to C₂₅ aliphatic hydrocarbons. The C₈ to C₂₅ aliphatic hydrocarbons includes octane, octene, octyne, nonane, nonene, nonyne, decane, decene, decyne, undecane, undecene, undecyne, dodecane, dodecene, dodecyne, tridecane, tridecene, tridecyne, tetradecane, tetradecene, tetradecyne, pentadecane, pentadecene, pentadecyne, hexadecane, hexadecene, hexadecyne, heptadecane, heptadecene, heptadecyne, octadecane, octadecene, octadecyne nonadecane, nonadecene, nonadecyne, icosane, henicosane, docosane, tricosane, tetracosane, pentacosane or mixtures thereof. In a preferred embodiment, the hydrocarbon-containing fluid includes dodecane. In some embodiments, the hydrocarbon-containing fluid is dodecane, and the residue gas stream includes H₂, BTX, C₅-C₆ hydrocarbon, a C₄ olefin, propylene, ethylene, ethane, methane, CO, CO₂, or mixtures thereof. The BTX includes benzene, toluene, ethylbenzene, p-xylene, m-xylene, o-xylene, or mixtures thereof. The C₅-C₆ hydrocarbon includes pentane, pentene, pentyne, hexane, hexene, hexyne, cyclohexane, cyclohexene, or mixtures thereof.

In some embodiments, the method results in a hydrocarbon conversion of at least up to 85%, preferably 90%, preferably 95%, based on the initial weight of the hydrocarbon present in the hydrocarbon-containing fluid. In some embodiments, the method results in a H₂ yield of 50-80%, preferably 51-79%, preferably 52-78%, preferably 53-77%, preferably 54-76%, preferably 55-75%, preferably 56-74%, preferably 57-73%, preferably 58-72%, preferably 59-71%, preferably 60-70%, preferably 61-69%, preferably 62-68%, preferably 63-67%, and preferably 64-66%, based on the hydrocarbon conversion. In a preferred embodiment, the method has a H₂ yield of up to 72.7%, based on the hydrocarbon conversion.

At step 60, the method 50 includes separating the H₂ from the residue gas stream to generate a H₂-containing product gas stream. The H₂ may be separated from the residue gas stream by any of the techniques known in the art.

FIG. 1B illustrates a flow chart of a method 80 for preparing the Ni-SRM catalyst. The order in which the method 80 is described is not intended to be construed as a limitation, and any number of the described method steps can be combined in any order to implement the method 80. Additionally, individual steps may be removed or skipped from the method 80 without departing from the spirit and scope of the present disclosure.

At step 82, the method 80 includes calcining a red mud material at a temperature of about 600-900° C. to form a calcined red mud material. The calcination of the red mud material is carried out by heating it to a high temperature, under a restricted supply of ambient oxygen. This is performed to remove impurities or volatile substances and to incur thermal decomposition. Typically, the calcination is carried out in a furnace, preferably equipped with a temperature control system, which may provide a heating rate of up to 50° C./min, preferably up to 40° C./min, preferably up to 30° C./min, preferably up to 20° C./min, preferably up to 10° C./min, preferably up to 5° C./min, preferably up to 2° C./min, and preferably up to 1° C./min. In some embodiments, the reaction mixture is calcined at a temperature of 600-900° C., preferably 610-890° C., preferably 620-880° C., preferably 630-870° C., preferably 640-860° C., preferably 650-850° C., preferably 660-840° C., preferably 670-830° C., preferably 680-820° C., preferably 690-810° C., preferably 700-800° C., preferably 710-790° C., preferably 720-780° C., preferably 730-770° C., and preferably 740-760° C. In a preferred embodiment, the method includes calcining the red mud material at a temperature of about 750° C. to form the calcined red mud material. In some embodiments, the red mud material has an average particle size of about 80-150 μm, preferably 85-145 μm, preferably 90-140 μm, preferably 95-135 μm, preferably 100-130 μm, preferably 105-125 μm, preferably 110-120 μm.

At step 84, the method 80 includes mixing a nickel salt and a first solvent to form a first mixture. The nickel salt may include one or more of nickel sulfate, nickel acetate, nickel citrate, nickel iodide, nickel chloride, nickel perchlorate, nickel nitrate, nickel phosphate, nickel triflate, nickel bis(trifluoromethanesulfonyl)imide, nickel tetrafluoroborate, nickel bromide, and/or its hydrate. The solvent may be one or more of water, methanol, ethanol, acetone, dimethyl sulfoxide (DMSO), dimethylformamide (DMF), dimethylacetamide, isopropanol, benzene, hexane, carbon tetrachloride, toluene, diethyl ether, tetrahydrofuran, chloroform, or a mixture thereof. The water may be tap water, distilled water, bidistilled water, deionized water, deionized distilled water, reverse osmosis water, and/or some other water. In a preferred embodiment, the solvent is deionized water. The mixing may be carried out manually or with the help of a stirrer.

At step 86, the method 80 includes adjusting the pH of the first mixture to about 9 and mixing with the calcined red mud material to form a reaction mixture. The pH may be adjusted by adding an alkali solution into the first mixture, and wherein the alkali solution comprises at least one alkali salt selected from the group consisting of potassium hydroxide (KOH), sodium hydroxide (NaOH), calcium hydroxide (Ca(OH)₂), potassium carbonate (K₂CO₃), sodium carbonate (Na₂CO₃), calcium carbonate (Ca₂CO₃), or mixtures thereof. In a preferred embodiment, the pH may be adjusted using KOH and K₂CO₃. The mixing may be carried out manually, with the help of a stirrer, or via ultrasonication.

At step 88, the method 80 includes heating the reaction mixture to form a catalyst precursor in the reaction mixture. The heating can be done by using heating appliances such as hot plates, heating mantles, hot air ovens, microwaves, autoclaves, tapes, oil baths, salt baths, sand baths, air baths, hot-tube furnaces, and hot-air guns. In a preferred embodiment, the heating of the reaction mixture can be done by using a hot air oven.

At step 90, the method 80 includes precipitating the catalyst precursor from the reaction mixture by cooling and calcining at a temperature of 500-600° C., preferably 510-590° C., preferably 520-580° C., preferably 530-570° C., and preferably 540-560° C. to form the Ni-SRM catalyst. The precipitate may be separated from the reaction mixture by methods including, but not limited to, filtration, decantation, and evaporation. In a preferred embodiment, the reaction mixture is calcined at a temperature of 550° C. for 5 h to form the Ni-SRM catalyst.

In some embodiments, Ni is present in the Ni-SRM catalyst at a concentration of 0.01-30 wt. %, preferably 0.5-29.5 wt. %, preferably 1-29 wt. %, preferably 2-28 wt. %, preferably 3-27 wt. %, preferably 4-26 wt. %, preferably 5-25 wt. %, preferably 6-24 wt. %, preferably 7-23 wt. %, preferably 8-22 wt. %, preferably 9-21 wt. %, preferably 10-20 wt. %, preferably 11-19 wt. %, preferably 12-18 wt. %, preferably 13-17 wt. %, preferably 14-16 wt. %, based on the total weight of the Ni-SRM catalyst. In some embodiments, the Ni is present in the Ni-SRM catalyst at a concentration of 10-20 wt. %, preferably 11-19 wt. %, preferably 12-18 wt. %, preferably 13-17 wt. %, preferably 14-16 wt. %, based on the total weight of the Ni-SRM catalyst.

### EXAMPLES

The following examples demonstrate a method for producing hydrogen. The examples are provided solely for illustration and are not to be construed as limitations of the present disclosure, as many variations thereof are possible without departing from the spirit and scope of the present disclosure.

### Example 1: Chemicals

Red mud was collected from a mining industry from Saudi Arabia. The material, alternatively referred to as Saudi red mud (SRM) was first crushed to below 100 micrometers (μm) and calcined at 750 degrees Celsius (° C.) to remove any impurities. Further, nickel (Ni) with different concentrations was loaded into the SRM.

### Example 2: Synthesis of Ni-SRM Catalyst Via Physical Mixing

A Ni source that corresponds to 20 wt. % Ni of the amount of the calcined SRM was mixed with SRM; the sample was designated as 20Ni-SRM-P. Then, the sample was heated up to 750° C. in two stages, at the first stage, the sample was heated up to 500° C. at a heating range of 4° C./min for 3 hours (h), then at a second stage, heating the sample at a heating rate of 2° C./min to reach 750° C. and dwelled for 3 h.

### Example 3: Synthesis of 10Ni-SRM and 20Ni-SRM Catalyst

A nickel source that corresponds to 20 wt. % Ni of the amount of the calcined SRM was dissolved in 10 milliliters (ml) of deionized water. A solution consisting of 30 mL of 1M KOH and 30 mL of 0.1M of K₂CO₃ was prepared. Further, the Ni solution was added to 6 grams (g) of the SRM that was previously sonicated in a probe sonicator for 20 min. Following this, the KOH and K₂CO₃ solution was added. The final mixture was heated at 80° C. for 1 h under mechanical agitation. Then, the slurry was transferred to an oven and heated for another hour. The solid material was separated and washed with water. Finally, the material was heated at 550° C. for 5 h to yield a 20Ni-SRM catalyst.

A nickel source that corresponds to 10 wt. % Ni of the amount of the calcined SRM was dissolved in 10 mL of deionized water. A solution consisting of 30 mL of 1M KOH and 30 mL of 0.1 M of K₂CO₃ was prepared. Next, the Ni solution was added to 6 g of the SRM that was previously sonicated in a prob sonicator for 20 min. Following this, the KOH and K₂CO₃ solution was added. The final mixture was heated at 80° C. for 1 h under mechanical agitation. Then, the slurry was transferred to an oven and heated for another hour. The solid material was separated and washed with water. Finally, the material was heated at 550° C. for 5 h to yield 10 Ni-SRM catalyst.

### Example 4: Catalyst Evaluation

The activity of the materials in hydrogen production via steam reforming of diesel. As such, dodecane, as a model compound, was evaluated in a fixed-bed reactor. Around 0.2 g of the targeted catalysts were first loaded into a quartz tube that was placed in an electrical furnace, as shown in FIG. 1B. Dodecane tank was prepared, and a high performance liquid chromatography (HPLC) pump was used to flow the feed at a flow rate of 0.02 milliliters per minute (mL/min). Similarly, the water tank was prepared for the generation of steam. Prior to the reaction, the catalysts were calcined at the reaction temperature in the presence of hydrogen to reduce the catalysts. The reaction temperature was 700° C. while the weight hourly space velocity (WHSV) was kept at 4.5 h⁻¹.

### Example 5: Catalyst Characterization

Structural patterns of prepared catalyst systems were investigated using an X-ray diffraction system from Rigaku Mini-flex II in the 20 range of 5° to 80°. In addition, the acidity, basicity, and Ni reducibility were measured on the Belcat II temperature-programmed desorption system. The acidity and basicity were measured on reduced catalyst systems.

### Example 6: Physiochemical Properties of Prepared Catalyst Systems

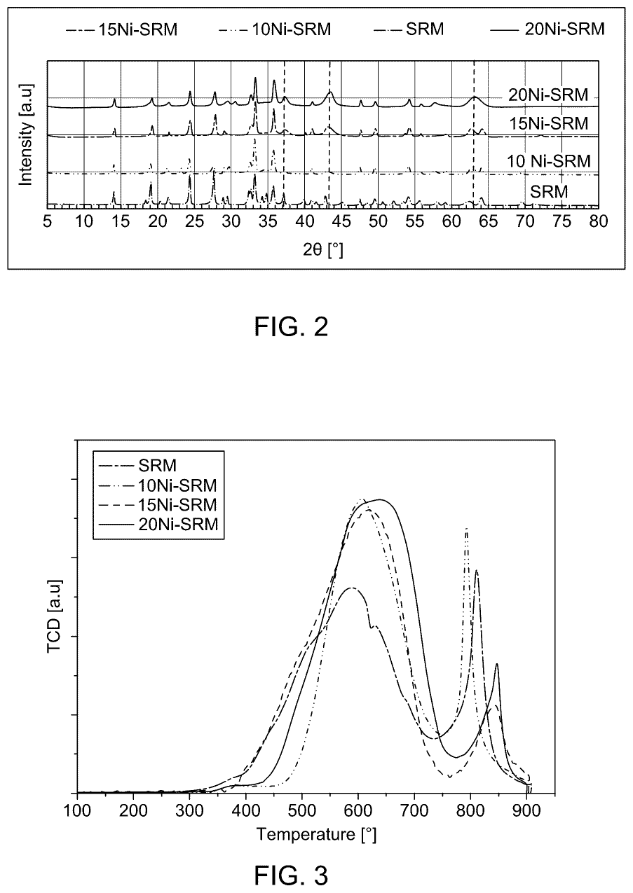

Referring to FIG. 2, a graph showing X-ray diffraction (XRD) patterns of the SRM before and after modification with Ni and alkaline earth metals is illustrated. As can be seen from FIG. 2, Ni loading was confirmed by the presence of XRD peaks of NiO at 2θ 32.7°, 43.2°, and 62.9°. The peak position is also acceptable. It was noted that, with the increase in Ni concentration, the NiO peaks are also increased. The hydrogen temperature programmed reduction (H₂-TPR) analysis is shown in FIG. 3. As can be seen from FIG. 3, the H₂-TPR analysis confirmed the loading of Ni to the SRM.

### Example 7: Catalytic Activity in Hydrogen Production

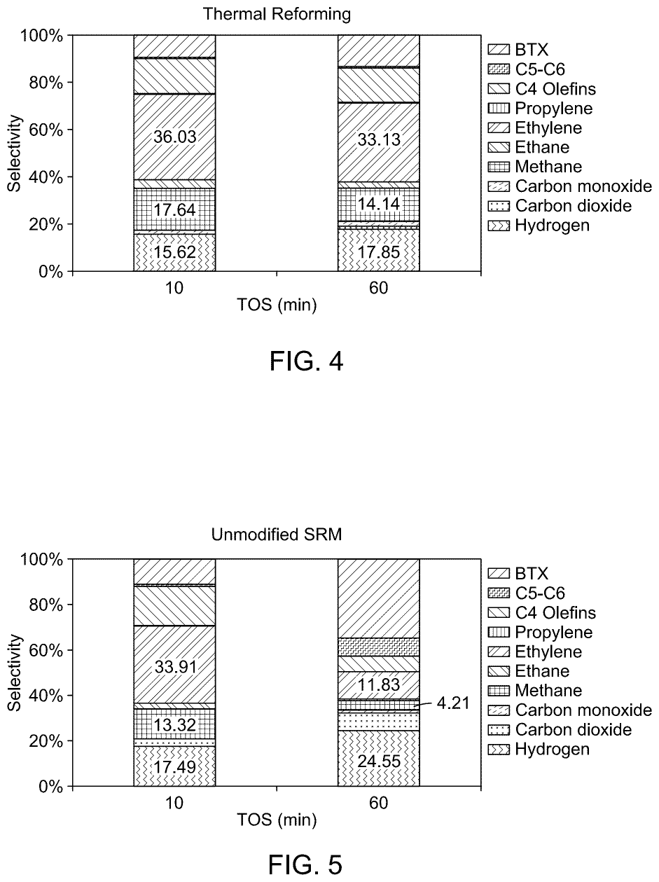

The performance of the SRM and modified SRM was evaluated using a fixed bed reactor in the presence of steam by following the procedure as mentioned above. A thermal steam reforming reaction was conducted to inspect performance enhancements, if any, for the above-mentioned catalysts. FIG. 4 shows the product distribution of the thermal steam reforming n-dodecane. The results confirm the wide range of products and the low selectivity to hydrogen, which make the process economically unfavorable and cause additional separation costs.

To underscore the role of waste material modifications in enhancing hydrogen production, unmodified SRM performance was assessed initially. FIG. 5 shows the product distribution of n-dodecane over unmodified SRM. It shows the enhancement of hydrogen selectivity upon utilizing unmodified SRM. Specifically, hydrogen selectivity witnessed a rise from approximately 17.5% to around 24.5% at a time on steam (TOS) of 60 min. This enhancement in selectivity was due to a reduction in the selectivity of both methane and olefins; as such, the selectivity of methane and olefins decreased from about 14.1% to 4.2% and from 33.1% to 11.8%, respectively.

$$Product selectivity ( \% ) = \frac{Moles of desired product \times 100}{Moles of total products}$$

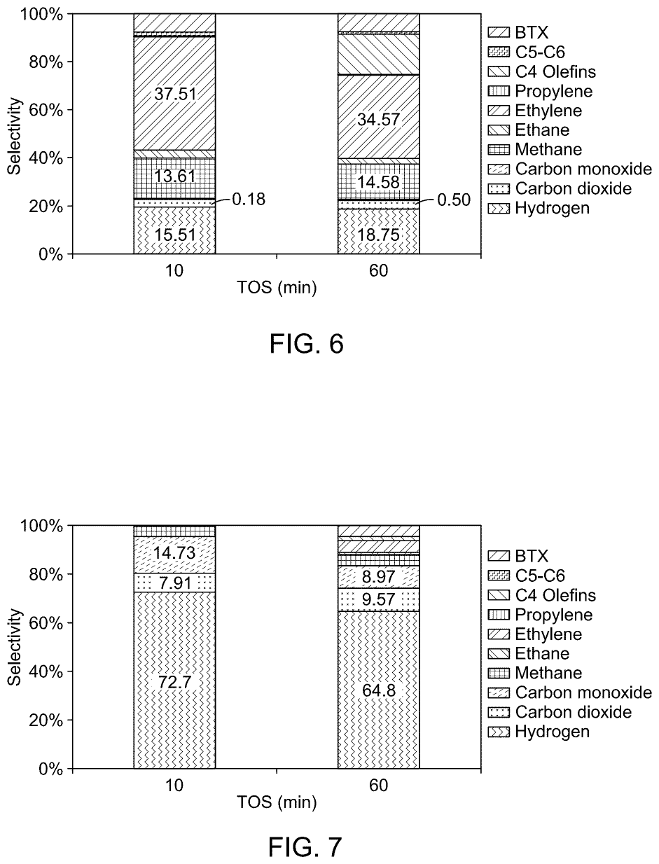

FIG. 6 shows the product distribution of steam reforming of n-dodecane over modified red mud with 10 weight percentage (wt. %) of Ni. The Ni modification of the SRM at a low Ni content of about 10 wt. % showed no significant effect on hydrogen selectivity. However, the introduction of a 20 wt. % Ni content to the SRM resulted in an improvement in the selectivity for hydrogen production. Specifically, after this modification, the hydrogen selectivity reached an impressive 72.7%, as shown in FIG. 7 which shows product distribution of steam reforming of n-dodecane over modified red mud with 20 wt. % of Ni. Concurrently, the hydrogen to carbon monoxide (H₂/CO) ratio was recorded at 4.9, after 10 min into the reaction. However, as the reaction progressed, there was a noticeable decline in hydrogen selectivity, settling at 64.8%, while the H₂/CO ratio increased to 7.2. This change suggests a dynamic behavior of the modified catalyst over the course of the reaction.

Modifying SRM waste for catalytic purposes has provided significant improvements in the structural and functional properties of catalyst systems. Through the use of characterization techniques such as XRD and TPR, the incorporation of nickel into the SRM was successfully confirmed. XRD patterns have shown concentration-dependent modifications with observable NiO peaks, while H₂-TPR analysis has unequivocally confirmed the presence of Ni through distinctive reduction peaks. Additionally, NH₃-TPR results have highlighted dynamic changes in acidity with varying Ni concentrations. Further, catalytic evaluation in hydrogen production has demonstrated a transformative impact of Ni modification on SRM, with 20 wt. % Ni content achieving a 72.7% hydrogen selectivity. The present disclosure underscores the potential of waste material modifications; these findings provide valuable insights into catalyst development and may offer a sustainable and efficient catalytic process with varying applications in a plurality of industries.

Numerous modifications and variations of the present disclosure are possible in light of the above teachings. It is therefore to be understood that within the scope of the appended claims, the invention may be practiced otherwise than as specifically described herein.

1: A method for producing hydrogen (H₂), comprising:
introducing a H₂-containing feed gas stream into a reactor containing a red mud supported nickel (Ni-SRM) catalyst comprising Ni-SRM catalyst particles;
wherein Ni is present in the Ni-SRM catalyst at a concentration of 0.01 to 30 wt. % based on a total weight of the Ni-SRM catalyst;
passing the H₂-containing feed gas stream through the reactor to contact the H₂-containing feed gas stream with the Ni-SRM catalyst particles at a temperature of from 600 to 800° C. to form an activated Ni-SRM catalyst;
terminating the introducing the H₂-containing feed gas stream;
simultaneously introducing and passing a hydrocarbon-containing fluid and a water vapor stream through the reactor to contact the hydrocarbon-containing fluid and the water vapor stream with the activated Ni-SRM catalyst at a temperature of from 600 to 800° C. thereby converting at least a portion of the hydrocarbon to H₂, and producing a residue gas stream leaving the reactor; and
separating the H₂ from the residue gas stream to generate a H₂-containing product gas stream.

2: The method of claim 1, wherein the reactor is at least one selected from the group consisting of a fixed-bed reactor, a trickle-bed reactor, a moving bed reactor, a rotating bed reactor, a fluidized bed reactor, and a slurry reactor.

3: The method of claim 1, wherein the reactor is a fixed-bed reactor in the form of a cylindrical reactor comprising:
a top portion;
a cylindrical body portion;
a bottom portion;
a housing having an open top and open bottom supportably maintained with the cylindrical body portion;
wherein the Ni-SRM catalyst is supportably retained within the housing permitting fluid flow therethrough;
at least one propeller agitator is disposed in the bottom portion of the reactor;
wherein the bottom portion is cone shaped or pyramidal; and
wherein a plurality of recirculation tubes fluidly connects the bottom portion of the cylindrical reactor with the cylindrical body portion of the cylindrical reactor.

4: The method of claim 1, wherein the H₂ is present in the H₂-containing feed gas stream at a concentration of 90 to 99.99 vol. % based on a total volume of the H₂-containing feed gas stream.

5: The method of claim 1, wherein the hydrocarbon is present in the hydrocarbon-containing fluid at a concentration of 50 to 95 vol. % based on a total volume of the hydrocarbon-containing fluid.

6: The method of claim 1, wherein the hydrocarbon-containing fluid further comprises an inert gas selected from the group consisting of nitrogen, argon, and helium.

7: The method of claim 1, wherein a flow rate of the hydrocarbon-containing fluid to the water vapor stream introduced into the reactor is about 5:1 to 1:5.

8: The method of claim 1, wherein the introducing and passing of the hydrocarbon-containing fluid and the water vapor stream through the reactor is performed at a weight hourly space velocity (WHSV) of about 4.5 h⁻¹ at a temperature of about 700° C.

9: The method of claim 1, wherein the hydrocarbon-containing fluid is a diesel oil comprising one or more C8 to C25 aliphatic hydrocarbons.

10: The method of claim 9, wherein the hydrocarbon-containing fluid comprises dodecane.

11: The method of claim 1, wherein the hydrocarbon-containing fluid is dodecane, and wherein the residue gas stream comprises H₂, BTX, C5-C6 hydrocarbon, a C4 olefin, propylene, ethylene, ethane, methane, CO, CO₂, or mixtures thereof.

12: The method of claim 11, wherein the BTX comprises benzene, toluene, ethylbenzene, p-xylene, m-xylene, o-xylene, or mixtures thereof.

13: The method of claim 11, wherein the C5-C6 hydrocarbon comprises pentane, pentene, pentyne, hexane, hexene, hexyne, cyclohexane, cyclohexene, or mixtures thereof.

14: The method of claim 1, wherein the method has a hydrocarbon conversion of at least to 85% based on an initial weight of the hydrocarbon present in the hydrocarbon-containing fluid.

15: The method of claim 14, wherein the method has a H₂ yield of 50 to 80% based on the hydrocarbon conversion.

16: The method of claim 1, further comprising:
preparing the Ni-SRM catalyst by:
calcining a red mud material at a temperature of about 600 to 900° C. to form a calcined red mud material;
mixing a nickel salt and a first solvent to form a first mixture;
adjusting a pH of the first mixture to about 9, and mixing with the calcined red mud material to form a reaction mixture;
heating the reaction mixture to form a catalyst precursor in the reaction mixture; and
precipitating the catalyst precursor from the reaction mixture by cooling and calcining at a temperature of about 550° C. to form the Ni-SRM catalyst;
wherein the Ni is present in the Ni-SRM catalyst at a concentration of 10 to 20 wt. % based on a total weight of the Ni-SRM catalyst.

17: The method of claim 16, wherein the red mud material has an average particle size of about 80 to 150 μm.

18: The method of claim 16, wherein the calcining is performed at a temperature of about 750° C.

19: The method of claim 16, wherein the nickel salt comprises nickel sulfate, nickel acetate, nickel citrate, nickel iodide, nickel chloride, nickel perchlorate, nickel nitrate, nickel phosphate, nickel triflate, nickel bis(trifluoromethanesulfonyl)imide, nickel tetrafluoroborate, nickel bromide, and/or its hydrate.

20: The method of claim 16, wherein the adjusting the pH is performed by adding an alkali solution into the first mixture, and wherein the alkali solution comprises at least one alkali salt selected from the group consisting of potassium hydroxide (KOH), sodium hydroxide (NaOH), calcium hydroxide (Ca(OH)₂), potassium carbonate (K₂CO₃), sodium carbonate (Na₂CO₃), calcium carbonate (Ca₂CO₃), or mixtures thereof.
